(19) United States
(12) Patent Application Publication
(10) Pub. No.: US 2018/0170122 A1
(43) Pub. Date: Jun. 21, 2018

(54) PNEUMATIC TIRE

(71) Applicant: TOYO TIRE & RUBBER CO., LTD., Itami-shi (JP)

(72) Inventor: Kazuki Kawakami, Itami-shi (JP)

(73) Assignee: TOYO TIRE & RUBBER CO., LTD., Itami-shi (JP)

(21) Appl. No.: 15/793,083

(22) Filed: Oct. 25, 2017

(30) Foreign Application Priority Data
Dec. 21, 2016 (JP) 2016-247644

(51) Int. Cl. B60C 19/08

(52) U.S. Cl. CPC B60C 19/082; B60C 2011/0016

(57) ABSTRACT

In A pneumatic tire, a conductive portion is arranged between peripheral grooves in the outermost side in a tire width direction and is arranged in a land portion including a whole void ratio maximum difference position. The whole void ratio maximum difference position is a position where a difference of a void ratio between one side and the other side in the tire width direction becomes maximum in a void ratio of the outer surface between ground ends of a tread rubber in the tire width direction.

### CROSS REFERENCE TO RELATED APPLICATIONS

This application claims the benefit of priority of Japanese application no. 2016-247644, filed on Dec. 21, 2016, which is incorporated herein by reference.

### BACKGROUND OF THE INVENTION

### Field of the Invention

The present invention relates to a pneumatic tire having a conductive portion which is formed by a conductive rubber.

### Description of the Related Art

Conventionally, as a pneumatic tire, there has been known a pneumatic tire having a conductive portion which is formed by a conductive rubber (for example, JP-A-08-34204 and JP-A-2013-23200). The conductive portion extends toward an inner side in a tire radial direction from an outer surface of a tread rubber. As a result, it is possible to secure a conductive property from a vehicle to a road surface, however, a tire performance has tended to be lowered.

### SUMMARY OF THE INVENTION

Accordingly, an object of the present invention is to provide a pneumatic tire which can suppress reduction of a tire performance while securing a conductive property from a vehicle to a road surface.

There is provided a pneumatic tire, which includes:
a tread rubber having a plurality of peripheral grooves which extend along a tire peripheral direction, and a plurality of land portions which are sectioned by the plurality of peripheral grooves, in an outer surface side which is grounded on a road surface,
wherein the tread rubber includes:
a non-conductive portion which is formed by a non-conductive rubber; and
a conductive portion which is formed by a conductive rubber and extends from an outer surface toward an inner side in a tire radial direction,
wherein the conductive portion is arranged between the peripheral grooves in the outermost side in a tire width direction and is arranged in a land portion including a whole void ratio maximum difference position, and
wherein the whole void ratio maximum difference position is a position where a difference of a void ratio between one side and the other side in the tire width direction becomes maximum in a void ratio of the outer surface between ground ends of the tread rubber in the tire width direction.

Further, the pneumatic tire may have a configuration in which:
at least a part of the conductive portion is arranged between the whole void ratio maximum difference position and a land portion void ratio maximum difference position, and
wherein the land portion void ratio maximum difference position is a position where the difference of the void ratio between the one side and the other side in the tire width direction becomes maximum in the void ratio of the outer surface in the land portion including the whole void ratio maximum difference position.

Further, the pneumatic tire may have a configuration in which:
the conductive portion is arranged closer to the whole void ratio maximum difference position than the land portion void ratio maximum difference position.

Further, the pneumatic tire may have a configuration in which:
the conductive portion is arranged so as to include a peripheral whole length void ratio minimum position, and
wherein the peripheral whole length void ratio minimum position is a position where a void ratio in a whole length in a tire peripheral direction becomes minimum in the outer surface of the land portion including the whole void ratio maximum difference position.

Further, the pneumatic tire may have a configuration in which:
the conductive portion is arranged so as to be inclined toward a wearing time land portion void ratio maximum difference position from the outer surface in relation to the tire radial direction, and
wherein the wearing time land portion void ratio maximum difference position is a position where the difference of the void ratio between the one side and the other side in the tire width direction becomes maximum in a void ratio at a position of 50% of a depth of the peripheral groove in the land portion including the whole void ratio maximum difference position.

Further, the pneumatic tire may have a configuration in which:
the conductive portion is arranged so as to be inclined toward one side in the tire width direction from the outer surface in relation to the tire radial direction, and
wherein the void ratio in the one side in the tire width direction is larger than the void ratio in the other side in the void ratio at a position of 50% of a depth of a peripheral groove in the land portion including the whole void ratio maximum difference position.

Further, the pneumatic tire may have a configuration in which:
a width of the conductive portion is smaller than a width of the peripheral groove.

Also, the pneumatic tire may have a configuration in which:
a width of the conductive portion is equal to or less than 5 mm.

Also, the pneumatic tire may have a configuration in which:
a width of the conductive portion is equal to or less than 2 mm.

Further, the pneumatic tire may have a configuration in which:
a width of the conductive portion is equal to or less than 0.5 mm.

As mentioned above, the pneumatic tire achieves an excellent effect that the pneumatic tire can suppress the reduction of the tire performance while securing the conductive property from the vehicle to the road surface.

### BRIEF DESCRIPTION OF DRAWINGS

FIG. 1 is a drawing of a substantial part of a pneumatic tire according to an embodiment and is a cross sectional view in a tire meridian surface;

FIG. 2 is a development view of a substantial part of a tread surface of the pneumatic tire according to the embodiment;

FIG. 3 is a drawing describing a land portion and a boundary of grooves in FIG. 2;

FIG. 4 is an enlarged view of an area IV in FIG. 1; and

FIG. 5 is an enlarged view of a substantial part of a pneumatic tire according to the other embodiment and is a cross sectional view in a tire meridian surface.

### DETAILED DESCRIPTION OF THE INVENTION

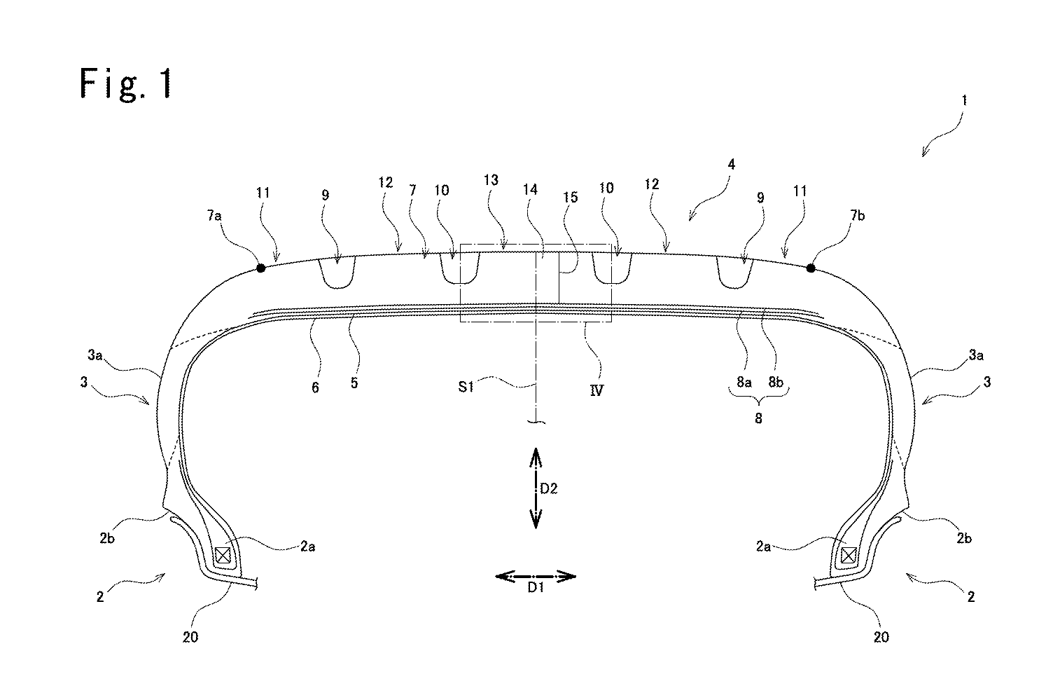

A description will be given below of an embodiment in a pneumatic tire with reference to FIGS. 1 to 4. In each of the drawings (in the same manner as FIG. 5), a dimensional ratio of the drawing does not necessarily coincides with an actual dimensional ratio, and the dimensional ratio does not necessarily coincide between the drawings.

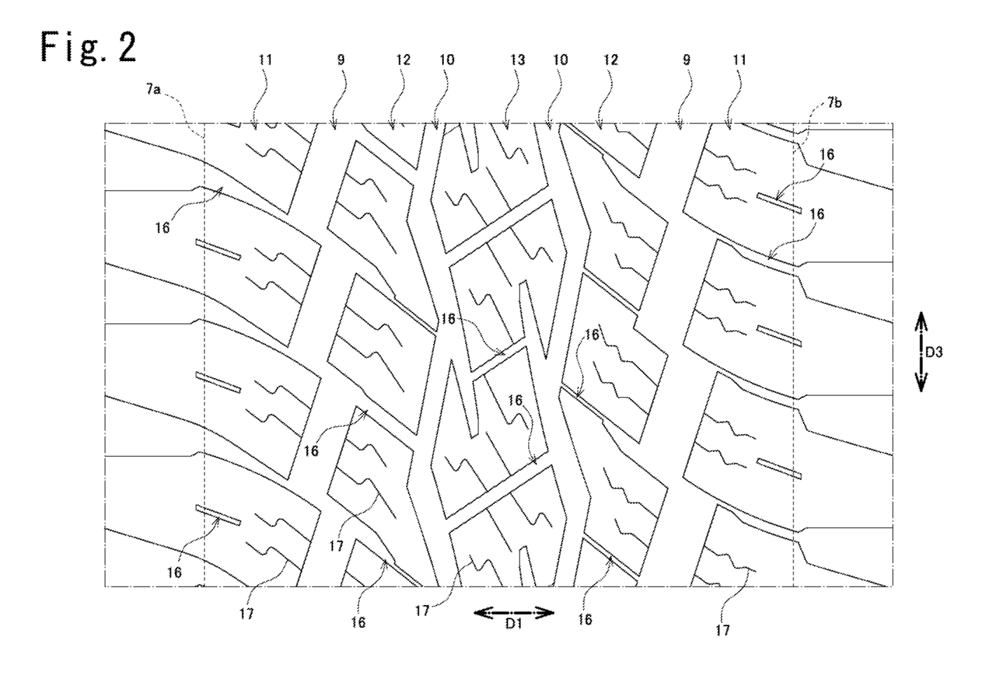

In FIG. 1 (same applies to the following drawings), a first direction D1 is a tire width direction D1 which is parallel to a tire rotation axis, a second direction D2 is a tire radial direction D2 which corresponds to a diametrical direction of the pneumatic tire (hereinafter, refer simply to as “tire”) 1, and a third direction D3 is a tire peripheral direction (refer to FIG. 2) D3 which is around the tire rotation axis. Further, a tire equator surface S1 is a surface which is orthogonal to the tire rotation axis and is also a surface which is positioned at the center in the tire width direction D1, and a tire meridian surface is a surface which includes the tire rotation axis and is also a surface which is orthogonal to the tire equator surface S1.

As shown in FIG. 1, the tire 1 according to the present embodiment is provided with a pair of bead portions 2 which have beads 2a, side wall portions 3 which extend from the respective bead portions 2 to an outer side in the tire radial direction D2, and a tread portion 4 which is connected to outer end portions of a pair of side wall portions 3 in the tire radial direction D2, and constructs a tread surface coming into contact with a road surface by its outer surface. The tire 1 is installed to a rim 20, and an internal portion of the tire 1 is pressurized by the air.

The tire 1 is provided with a carcass layer 5 which is bridged between a pair of beads 2a and 2a, and an inner liner 6 which is arranged in an inner side of the carcass layer 5 and is excellent in a function of blocking transmission of the gas for keeping the pneumatic pressure. The carcass layer 5 and the inner liner 6 are arranged along a tire inner periphery over the bead portions 2, the side wall portions 3 and the tread portion 4.

The carcass layer 5 is constructed by one carcass ply in the present embodiment. The carcass ply is folded back around the bead 2a so as to wind up the bead 2a. Further, the carcass ply is provided with a cord and a topping rubber which coats the cord.

The bead portion 2 is provided with a rim strip rubber 2b which is arranged in an outer side of the carcass layer 5 in the tire width direction D1 so as to construct an outer surface. The rim strip rubber 2b is arranged in a portion which comes into contact with the rim 20. The side wall portion 3 is provided with a side wall rubber 3a which is arranged in an outer side of the carcass layer 5 in the tire width direction D1 so as to construct the outer surface.

The tread portion 4 is provided with a tread rubber 7 which is arranged in an outer peripheral side of the carcass layer 5, and a belt portion 8 which is arranged between the carcass layer 5 and the tread rubber 7, in such a manner that an outer surface constructs the tread surface. More specifically, the belt portion 8 is arranged in an outer peripheral side of the carcass layer 5, and is also arranged in an inner peripheral side of the tread rubber 7.

The belt portion 8 is provided with two layers of belt plies 8a and 8b in the present embodiment, for reinforcing the carcass layer 5. The belt portion 8 may be provided with a reinforcing ply in an outer side of the belt plies 8a and 8b in the tire radial direction D2 for reinforcing the belt plies 8a and 8b. The belt plies 8a and 8b and the reinforcing ply are provided with a cord, and a topping rubber which coats the cord.

The tread rubber 7 is provided in an outer surface side thereof with a plurality of peripheral grooves 9 and 10 which extend along the tire peripheral direction D3, and a plurality of land portions 11 to 13 which are sectioned by a plurality of peripheral grooves 9 and 10. In the present embodiment, four peripheral grooves 9 and 10 are provided, and five land portions 11 to 13 are provided. For example, it is preferable that three or more peripheral grooves 9 and 10 are provided, and it is more preferable that four or more peripheral grooves 9 and 10 are provided. The numbers of the peripheral grooves 9 and 10 and the land portions 11 to 13 are not limited to the structure mentioned above.

The peripheral groove 9 arranged in the outermost side in the tire width direction D1 is called as a shoulder peripheral groove 9, and the peripheral groove 10 arranged in an inner side in the tire width direction D1 than the shoulder peripheral groove 9 is called as a center peripheral groove 10. Further, the land portion 11 arranged in an outer side in the tire width direction D1 than the shoulder peripheral groove 9 is called as a shoulder land portion 11, the land portion 12 arranged between the shoulder peripheral groove 9 and the center peripheral groove 10 is called as a mediate land portion 12, and the land portion 13 arranged between the center peripheral grooves 10 and 10 is called as a center land portion 13.

Further, the tread rubber 7 is provided with a non-conductive portion 14 which is formed by a non-conductive rubber, and a conductive portion 15 which is formed by a conductive rubber and extends toward an inner side in the tire radial direction D2 from the outer surface. The conductive rubber is exemplified by a rubber in which a volume resistivity indicates a value which is less than 10⁸ Ω·cm, and is exemplified by a material obtained by blending a reinforcing material, for example, carbon black at a high ratio in a raw material rubber. Further, the non-conductive rubber is exemplified by a rubber in which the volume resistivity indicates a value which is equal to or more than 10⁸ Ω·cm, and is exemplified by a material obtained by blending a reinforcing material, for example, silica at a high ratio in the raw material rubber.

Further, in the tire 1 according to the present embodiment, the conductive portion 15 extends to the belt portion 8 from the outer surface of the tread rubber 7, and each of the topping rubbers of the belt portion 8, the topping rubber of the carcass layer 5 and the rim strip rubber 2b is formed by the conductive rubber. As a result, the tire 1 is provided with a conductive route which electrically connects the tread surface and the rim 20. The conductive route is not limited to the structure mentioned above, but may be structured such as to electrically connect the conductive portion 15 and the rim 20.

Further, the conductive portion 15 is arranged between the shoulder peripheral grooves 9 and 9 which are arranged in the outermost side in the tire width direction D1. As a result, since the conductive portion 15 is arranged between the ground ends 7a and 7b which are the outer ends in the tire width direction D1 among the ground surface where the outer surface (the tread surface) of the tread rubber 7 is grounded on the road surface, the conductive portion 15 is securely grounded on the road surface. The ground surface means the tread surface which is grounded on the road surface when the tire 1 is assembled in the normal rim 20, the tire 1 is vertically put on the flat road surface in a state in which the normal internal pressure is charged, and the normal load is applied to the tire.

The normal rim 20 is the rim 20 which is defined every tire 1 by a standard system including standards on which the tire 1 is based, for example, is a standard rim in JATMA, “Design Rim” in TRA, and “Measuring Rim” in ETRTO.

The normal internal pressure is the pneumatic pressure defined every tire 1 by the standard system including the standards on which the tire 1 is based, and is the maximum pneumatic pressure in JATMA, the maximum value described in “TIRE LOAD LIMITS AT VARIOUS COLD INFLATION PRESSURES” in TRA, and “INFLATION PRESSURE” in ETRTO, however, is 180 KPa in the case that the tire 1 is provided for a passenger car.

The normal load is a load defined every tire 1 by the standard system including the standards on which the tire 1 is based, and is the maximum load capacity in JATMA, the maximum value described in the above table in TRA, and “LOAD CAPACITY” in ETRTO, however, is 85% of the corresponding load to the internal pressure 180 KPa in the case that the tire 1 is provided for the passenger car.

As shown in FIG. 2, each of the peripheral grooves 9 and 10 is formed into a zigzag shape so as to extend along the tire peripheral direction D3. Each of the peripheral grooves 9 and 10 may be formed into a linear shape so as to be parallel to the tire peripheral direction D3.

The land portions 11 to 13 are provided with a plurality of land grooves 16 and 17 which extend like a concave shape so as to intersect the tire peripheral direction D3. The land grooves 16 and 17 are provided with a transverse groove 16 and a sipe 17 which is narrower than the transverse groove 16. For example, the transverse groove 16 means a concave portion in which a width thereof is equal to or more than 1.0 mm, and the sipe 17 means a concave portion in which a width thereof is less than 1.0 mm.

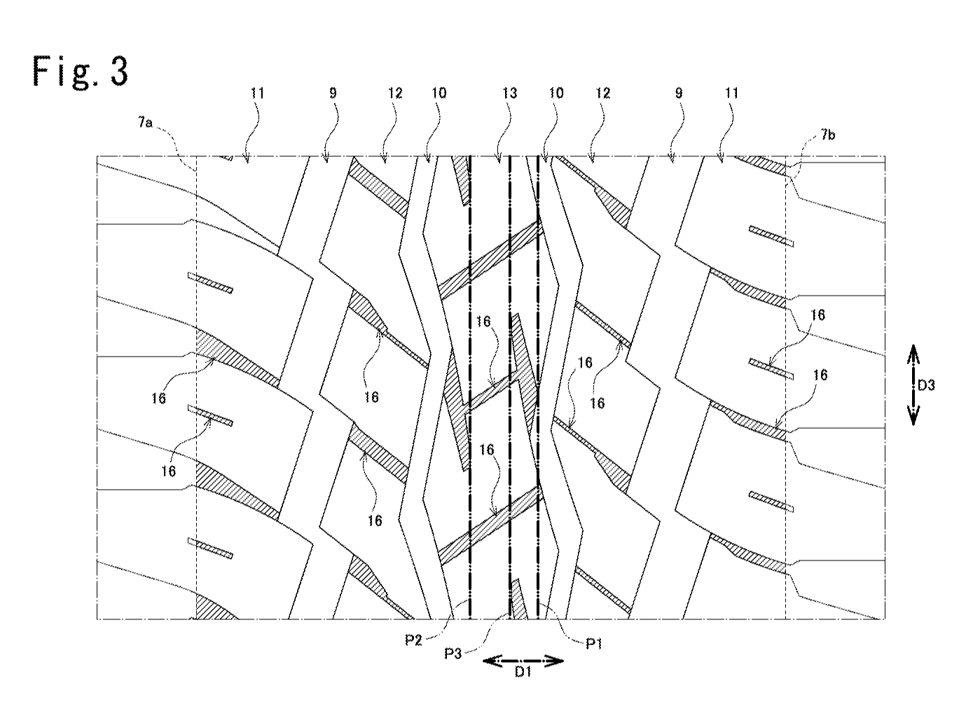

In FIG. 3, boundary lines of the land portions 11 to 13 (end edges of the peripheral grooves 9 and 10) are shown by solid lines, ground ends 7a and 7b are shown by broken lines, and an area of the transverse groove 16 is shown by a hatched portion. In this connection, when the area between the ground ends 7a and 7b is sectioned by a predetermined position, a void ratio of an outer surface in the area between the first ground end 7a and the predetermined position has the greatest difference from a void ratio of an outer surface between the second ground end 7b and the predetermined position in the case that the predetermined position is a first position (a whole void ratio maximum difference position) P1.

Therefore, the whole void ratio maximum difference position P1 is a position where a difference of the void ratio becomes maximum between one side (the area between the whole void ratio maximum difference position P1 and the first ground end 7a) and the other side (the area between the whole void ratio maximum difference position P1 and the second ground end 7b) in the tire width direction D1, in the void ratio of the outer surface of the tread rubber 7 between the ground ends 7a and 7b. The whole void ratio maximum difference position P1 is set to the position where the difference of the void ratio becomes maximum at the position between the outermost side peripheral grooves (the shoulder peripheral grooves in the present embodiment) 9 and 9 and excludes the outer position in the tire width direction D1 than the outermost peripheral groove 9.

The void ratio means a ratio of an area of the land grooves 16 and 17 in relation to an area of the land portions 11 to 13 (including the area of the land grooves 16 and 17). Therefore, the area of the peripheral grooves 9 and 10 is not considered in the void ratio.

Further, when the center land portion 13 including the whole void ratio maximum difference position P1 is sectioned at the predetermined position, the difference of the void ratio in the area between the one center peripheral groove 10 and the predetermined position becomes maximum from the void ratio of the outer surface between the other side center peripheral groove 10 and the predetermined position in the case that the predetermined position is a second position (a land portion void ratio maximum difference position) P2. Therefore, the land portion void ratio maximum difference position P2 is a position where the difference of the void ratio between the one side and the other side in the tire width direction D1 becomes maximum, in the void ratio of the outer surface in the land portion (the center land portion in the present embodiment) 13 including the whole void ratio maximum difference position P1.

Further, a peripheral whole length void ratio minimum position P3 is a position where the void ratio in a whole length of the tire peripheral direction D3 becomes minimum in the outer surface of the land portion 13 (the center land portion in the present embodiment) including the whole void ratio maximum difference position P1. More specifically, the peripheral whole length void ratio minimum position P3 is a position where an actual surface area (an area actually grounding on the road surface) corresponding to an area of the convex portion excluding the land grooves 16 and 17 becomes maximum in the land portion 13 including the whole void ratio maximum difference position P1.

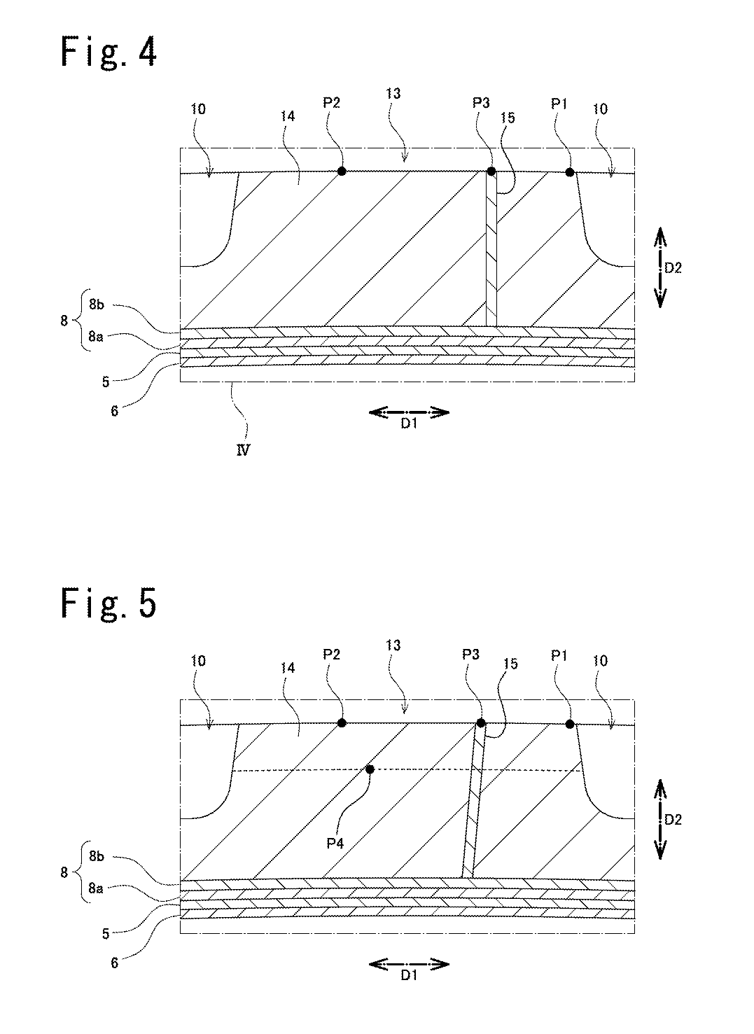

As shown in FIG. 4, the conductive portion 15 is arranged so as to be parallel to the tire radial direction D2. Further, the width of the conductive portion 15 (the width in the tire width direction D1) is fixed over the tire radial direction D2. Further, the width of the conductive portion 15 becomes smaller than the width of the peripheral grooves 9 and 10. For example, the width of the conductive portion 15 is equal to or less than 5 mm, is preferably equal to or less than 2 mm, and is further preferably equal to or less than 0.5 mm.

In this connection, since the rigidity difference is enlarged between the one side and the other side in relation to the whole void ratio maximum difference position P1 in a whole of the tire 1, a deformation is generated due to the rigidity difference between the one side and the other side in relation to the whole void ratio maximum difference position P1. Particularly, the deformation of the center land portion 13 including the whole void ratio maximum difference position P1 is enlarged. As a result, the tire performance is lowered.

Consequently, the conductive portion 15 is arranged in the center land portion 13 including the whole void ratio maximum difference position P1. As a result, since the conductive portion 15 sections the one side and the other side in the tire width direction D1, and segmentalizes the functions in the one side and the other side in the tire width direction D1, it is possible to suppress the influence of the rigidity difference between the one side and the other side in relation to the conductive portion 15.

Further, the deformation of the center land portion 13 is enlarged not only in the whole void ratio maximum difference position P1 but also in the land portion void ratio maximum difference position P2. Consequently, the conductive portion 15 is arranged between the whole void ratio maximum difference position P1 and the land portion void ratio maximum difference position P2. Specifically, the whole of the conductive portion 15 is arranged between the whole void ratio maximum difference position P1 and the land portion void ratio maximum difference position P2. As a result, it is possible to suppress the deformation caused by the rigidity difference between the one side and the other side in relation to the conductive portion 15, even in the center land portion 13.

The deformation of the center land portion 13 at the whole void ratio maximum difference position P1 tends to become larger than the deformation of the center land portion 13 at the land portion void ratio maximum difference position P2. Consequently, the conductive portion 15 is arranged closer to the whole void ratio maximum difference position P1 than the land portion void ratio maximum difference position P2. As a result, it is possible to effectively suppress the deformation caused by the rigidity difference between the one side and the other side in relation to the conductive portion 15, as a whole of the tire 1.

Further, the conductive portion 15 is arranged in such a manner as to include the peripheral whole length void ratio minimum position P3. As a result, it is possible to enlarge the area in which the conductive portion 15 is grounded on the road surface. Further, the conductive port ion 15 can be securely grounded on the road surface regardless of the position where the tire 1 is grounded on the road surface in the tire peripheral direction D3.

As described above, the pneumatic tire 1 according to the embodiment including: a tread rubber 7 having a plurality of peripheral grooves 9 and 10 which extend along a tire peripheral direction D3, and a plurality of land portions 11 to 13 which are sectioned by the plurality of peripheral grooves 9 and 10, in an outer surface side which is grounded on a road surface, wherein the tread rubber 7 includes: a non-conductive portion 14 which is formed by a non-conductive rubber; and a conductive portion 15 which is formed by a conductive rubber and extends from an outer surface toward an inner side in a tire radial direction D2, the conductive portion 15 is arranged between the peripheral grooves (the shoulder peripheral grooves 9 and 9 in this embodiment) in the outermost side in a tire width direction D1 and is arranged in a land portion (the center land portion 13 in this embodiment) including a whole void ratio maximum difference position P1, and the whole void ratio maximum difference position P1 is a position where a difference of a void ratio between one side and the other side in the tire width direction D1 becomes maximum in a void ratio of the outer surface between ground ends 7a and 7b of the tread rubber in the tire width direction D1.

According to the structure mentioned above, the conductive portion 15 is arranged between the peripheral grooves 9 and 9 which are arranged in the outermost side in the tire width direction D1. As a result, since the conductive portion 15 is arranged between the ground ends 7a and 7b of the tread rubber 7 in the tire width direction D1, the conductive portion 15 is securely grounded on the road surface . Therefore, it is possible to securely ensure the conductive property from the rim 20 (the vehicle) to the road surface.

In this connection, the whole void ratio maximum difference position P1 is the position where the difference of the void ratio between the one side and the other side in the tire width direction D1 becomes maximum in the void ratio of the outer surface between the ground ends 7a and 7b of the tread rubber 7 in the tire width direction D1. Therefore, since the rigidity difference between the one side and the other side in relation to the whole void ratio maximum difference position P1 is enlarged between the ground ends 7a and 7b, the deformation of the land portion 13 including the whole void ratio maximum difference position P1 tends to be enlarged.

Consequently, the conductive portion 15 is arranged in the land portion 13 including the whole void ratio maximum difference position P1. As a result, since the conductive portion 15 sections the one side and the other side in the tire width direction D1, and segmentalizes the functions of the one side and the other side in the tire width direction D1, it is possible to suppress the influence of the rigidity difference between the one side and the other side in relation to the conductive portion 15. Therefore, since it is possible to suppress the deformation of the land portions 11 to 13 caused by the rigidity difference between the one side and the other side in relation to the conductive portion 15, it is possible to suppress the reduction of the tire performance.

In the pneumatic tire 1 according to the embodiment, at least a part of the conductive portion 15 is arranged between the whole void ratio maximum difference position P1 and a land portion void ratio maximum difference position P2, and the land portion void ratio maximum difference position P2 is a position where the difference of the void ratio between the one side and the other side in the tire width direction D1 becomes maximum in the void ratio of the outer surface in the land portion (the center land portion 13 in this embodiment) including the whole void ratio maximum difference position P1.

According to the structure mentioned above, the land portion void ratio maximum difference position P2 is a position where the difference of the void ratio between the one side and the other side in the tire width direction D1 becomes maximum in the void ratio of the outer surface in the land portion 13 including the whole void ratio maximum difference position P1. Further, since the conductive portion 15 is arranged between the whole void ratio maximum difference position P1 and the land portion void ratio maximum difference position P2, the conductive portion 15 is arranged by taking into consideration not only the rigidity difference in a whole of the tire 1 between the ground ends 7a and 7b but also the rigidity difference in the land portion 13.

As a result, it is possible to suppress the influence of the rigidity difference between the one side and the other side in relation to the conductive portion 15 while segmentalizing the functions of the one side and the other side in relation to the conductive portion 15, not only in the whole of the tire 1 but also in the land portion 13. Therefore, since it is possible to suppress the deformation caused by the rigidity difference between the one side and the other side in relation to the conductive portion 15 not only in the whole of the tire 1 but also in the land portion 13, it is possible to effectively suppress the reduction of the tire performance.

In the pneumatic tire 1 according to the embodiment, the conductive portion 15 is arranged closer to the whole void ratio maximum difference position P1 than the land portion void ratio maximum difference position P2.

According to the structure mentioned above, since the conductive portion 15 is arranged closer to the whole void ratio maximum difference position P1 than the land portion void ratio maximum difference position P2, it is possible to effectively suppress the deformation of the land portions 11 to 13 caused by the rigidity difference between the one side and the other side in relation to the conductive portion 15 as a whole of the tire 1. As a result, it is possible to effectively suppress the reduction of the tire performance as a whole of the tire 1.

In the pneumatic tire 1 according to the embodiment, the conductive portion 15 is arranged so as to include a peripheral whole length void ratio minimum position P3, and the peripheral whole length void ratio minimum position P3 is a position where a void ratio in a whole length in a tire peripheral direction D3 becomes minimum in the outer surface of the land portion (the center land portion 13 in this embodiment) including the whole void ratio maximum difference position P1.

According to the structure mentioned above, the peripheral whole length void ratio minimum position P3 is a position where the void ratio in a whole length of the tire peripheral direction D3 becomes minimum on the outer surface of the land portion 13 including the whole void ratio maximum difference position P1. Further, since the conductive portion 15 is arranged in such a manner as to include the peripheral whole length void ratio minimum position P3, it is possible to enlarge the area in which the conductive portion 15 is grounded on the road surface. Therefore, it is possible to effectively secure the conductive property from the rim 20 (the vehicle) to the road surface.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

The pneumatic tire 1 according to the embodiment mentioned above is structured such that the conductive portion 15 is arranged so as to be parallel to the tire radial direction D2. However, the pneumatic tire 1 is not limited to the structure mentioned above. For example, as shown in FIG. 5, the conductive portion 15 may be structured such as to be arranged so as to be inclined to the tire radial direction D2.

In the structure mentioned above, the conductive portion 15 may be inclined at 0.5 degrees or more in relation to the tire radial direction D2, or may be inclined at 1 degree or more, or may be inclined in a range between 1 degree and 5 degrees. Further, in the structure mentioned above, the direction of incline of the conductive portion 15 may be determined on the basis of the void ratio at a position of 50% of the depth of the peripheral grooves 9 and 10 in the land portion 13 including the whole void ratio maximum difference position P1 (at 50% wearing time). In FIG. 5, a broken line shows the position of 50% of the peripheral grooves 9 and 10 (at the 50% wearing time).

For example, the pneumatic tire 1 may be structured, as shown in FIG. 5, such that the conductive portion 15 is arranged to be inclined toward a wearing time land portion void ratio maximum difference position P4 from the outer surface in relation to the tire radial direction D2, and the wearing time land portion void ratio maximum difference position P4 is a position where the difference of the void ratio between the one side and the other side in the tire width direction D1 becomes maximum in the void ratio at the position of 50% of the depth of the peripheral grooves 9 and 10 (at the 50% wearing time) in the land portion 13 including the whole void ratio maximum difference position P1.

According to the structure mentioned above, it is possible to suppress the deformation caused by the rigidity difference between the one side and the other side in relation to the conductive portion 15, not only in the case that the tire 1 does not wear (is new), but also in the case that the tire 1 wears by 50%. As a result, it is possible to effectively suppress the reduction of the tire performance from when the tire 1 does not wear (is new) to when the tire 1 wears.

Further, the pneumatic tire may be structured, for example, such that the conductive portion 15 is arranged so as to be inclined toward the one side in the tire width direction D1 from the outer surface in relation to the tire radial direction D2, and the void ratio in the one side in the tire width direction D1 is larger than the void ratio in the other side in the void ratio at the position of 50% of the depth of the peripheral groove in the land portion 13 including the whole void ratio maximum difference position P1.

According to the structure mentioned above, in correspondence to the matter that the larger the void ratio is, the smaller the rigidity becomes, the width of the land portion 13 becomes smaller little by little toward the inner side in the tire radial direction D2 in the side that the void ratio is larger (the one side in the tire width direction D1) at the position of 50% of the depth of the peripheral groove. As a result, it is possible to inhibit the rigidity difference between the one side and the other side in relation to the conductive portion 15 from being enlarged, when the tire 1 wears.

Further, the pneumatic tire 1 according to the embodiment mentioned above is structured such that the whole of the conductive portion 15 is arranged between the whole void ratio maximum difference position P1 and the land portion void ratio maximum difference position P2. However, the pneumatic tire 1 is not limited to the structure mentioned above. For example, the pneumatic tire 1 may be structured such that a part of the conductive portion 15 is arranged between the whole void ratio maximum difference position P1 and the land portion void ratio maximum difference position P2. Further, the pneumatic tire 1 may be structured, for example, such that the whole of the conductive portion 15 is arranged at the other positions than the position between the whole void ratio maximum difference position P1 and the land portion void ratio maximum difference position P2.

Further, the pneumatic tire 1 according to the embodiment mentioned above is structured such that the conductive portion 15 is arranged closer to the whole void ratio maximum difference position P1 than the land portion void ratio maximum difference position P2. However, the pneumatic tire 1 is not limited to the structure mentioned above. For example, the pneumatic tire 1 may be structured such that the conductive portion 15 is arranged closer to the land portion void ratio maximum difference position P2 than the whole void ratio maximum difference position P1.

Further, the pneumatic tire 1 according to the embodiment mentioned above is structured such that the conductive portion 15 is arranged so as to include the peripheral whole length void ratio minimum position P3. However, the pneumatic tire 1 is not limited to the structure mentioned above. For example, the pneumatic tire 1 may be structured such that the conductive portion 15 is arranged at a position which is deviated from the peripheral whole length void ratio minimum position P3.

Further, the pneumatic tire 1 according to the embodiment mentioned above is structured such that the width of the conductive portion 15 is fixed over the tire radial direction D2. However, the pneumatic tire 1 is not limited to the structure mentioned above. For example, the pneumatic tire 1 may be structured such that the width of the conductive portion 15 is variable. For example, the pneumatic tire 1 may be structured such that the width of the conductive portion 15 becomes larger toward the outer side in the tire radial direction D2 so as to improve the ground contact performance between the conductive portion 15 and the road surface.

What is claimed is:

1. A pneumatic tire comprising:
a tread rubber having a plurality of peripheral grooves which extend along a tire peripheral direction, and a plurality of land portions which are sectioned by the plurality of peripheral grooves, in an outer surface side which is grounded on a road surface,
wherein the tread rubber includes:
a non-conductive portion which is formed by a non-conductive rubber; and
a conductive portion which is formed by a conductive rubber and extends from an outer surface toward an inner side in a tire radial direction,
wherein the conductive portion is arranged between the peripheral grooves in the outermost side in a tire width direction and is arranged in a land portion including a whole void ratio maximum difference position, and
wherein the whole void ratio maximum difference position is a position where a difference of a void ratio between one side and the other side in the tire width direction becomes maximum in a void ratio of the outer surface between ground ends of the tread rubber in the tire width direction.

2. The pneumatic tire according to claim 1, wherein at least a part of the conductive portion is arranged between the whole void ratio maximum difference position and a land portion void ratio maximum difference position, and
wherein the land portion void ratio maximum difference position is a position where the difference of the void ratio between the one side and the other side in the tire width direction becomes maximum in the void ratio of the outer surface in the land portion including the whole void ratio maximum difference position.

3. The pneumatic tire according to claim 2, wherein the conductive portion is arranged closer to the whole void ratio maximum difference position than the land portion void ratio maximum difference position.

4. The pneumatic tire according to claim 1, wherein the conductive portion is arranged so as to include a peripheral whole length void ratio minimum position, and
wherein the peripheral whole length void ratio minimum position is a position where a void ratio in a whole length in a tire peripheral direction becomes minimum in the outer surface of the land portion including the whole void ratio maximum difference position.

5. The pneumatic tire according to claim 1, wherein the conductive portion is arranged so as to be inclined toward a wearing time land portion void ratio maximum difference position from the outer surface in relation to the tire radial direction, and
wherein the wearing time land portion void ratio maximum difference position is a position where the difference of the void ratio between the one side and the other side in the tire width direction becomes maximum in a void ratio at a position of 50% of a depth of the peripheral groove in the land portion including the whole void ratio maximum difference position.

6. The pneumatic tire according to claim 1, wherein the conductive portion is arranged so as to be inclined toward one side in the tire width direction from the outer surface in relation to the tire radial direction, and
wherein the void ratio in the one side in the tire width direction is larger than the void ratio in the other side in the void ratio at a position of 50% of a depth of a peripheral groove in the land portion including the whole void ratio maximum difference position.

7. The pneumatic tire according to claim 1, wherein a width of the conductive portion is smaller than a width of the peripheral groove.

8. The pneumatic tire according to claim 1, wherein a width of the conductive portion is equal to or less than 5 mm.

9. The pneumatic tire according to claim 8, wherein a width of the conductive portion is equal to or less than 2 mm.

10. The pneumatic tire according to claim 9, wherein a width of the conductive portion is equal to or less than 0.5 mm.
